(19) United States
(12) Patent Application Publication
(10) Pub. No.: US 2013/0078064 A1
(43) Pub. Date: Mar. 28, 2013

(54) Method of Storing and Retrieving Articles

(71) Applicants: Helmut KOSTMANN, Hart bei Graz (AT); Martin Trummer, Graz (AT); Heinrich Amminger, Hart bei Graz (AT)

(72) Inventors: Helmut KOSTMANN, Hart bei Graz (AT); Martin Trummer, Graz (AT); Heinrich Amminger, Hart bei Graz (AT)

(21) Appl. No.: 13/632,436

(22) Filed: Oct. 1, 2012

Related U.S. Application Data
(62) Division of application No. 12/309,759, filed on Mar. 31, 2009, now abandoned.

(30) Foreign Application Priority Data
Aug. 3, 2006 (AT) A 1304/2006

(51) Int. Cl. B65G 1/04

(52) U.S. Cl. 414/277

(57) ABSTRACT

The invention relates to a method for storing articles (21) in a set-down location (20), and retrieving them therefrom, with a load-bearing means (1) with a loading platform (2) which can be displaced transversally to a rack aisle (R) and, for receiving articles (21), is pushed between a rack shelf (24) and the articles (21). In order to enable a secure automatic retrieval of different articles (21) from a planar rack shelf (24) and the storing thereof, it is provided that the loading platform (2), as it receives articles, is lowered on the side facing the set-down location (20), preferably during displacement in a direction transverse to the rack aisle (R).

The invention relates to a method for storing articles in a set-down location, and retrieving them therefrom, with a load-bearing means with a loading platform which can be displaced transversally to a rack aisle and, for receiving articles, is pushed between a rack shelf and the articles. The invention relates further to a load-bearing means for storing articles in a set-down location, and retrieving them therefrom, comprising a loading platform which can be displaced transversally to a rack aisle and which, for receiving articles, is pushed between a rack shelf and the article.

In modern warehouse logistics, goods are frequently no longer stored in a warehouse in so-called storage boxes which ensure secure handling, but increasingly in original boxes from the production factory in order to prevent the logistic effort of repackaging the goods. The quality and the size of the box differ in such a way as the goods contained therein and their manufacturers. The major part of the goods is stored in warehouses on planar rack shelves. In order to enable the retrieval of these goods automatically, the following approaches were known to date:

A solution is known from DE 297 22 172 U1 in which a very precise stamp is guided into an also very precise opening and the gap is thus kept as small as possible so that there is no damage to the products to be retrieved and the stamp will still not get stuck. This method comes with the disadvantage that both the opening and the stamp need to be very precise in order to keep the distance between the load-bearing means and the product as small as possible and to avoid damaging the product, but at the same time to avoid jamming and retaining smooth running. Therefore, such storage locations are not considered for the major part of the products for economic reasons.

A solution is known from DE 102 41 347 A1 in which two wedges are guided into grooves in the rack shelves which penetrate beneath the merchandise. This method comes with the disadvantage that grooves need to be provided for the receptacles of the wedges in the rack shelves, thus leading to additional economic costs. When these grooves are not present, the products to be retrieved need to be provided with a fitting rounded portion or inevitably damage to products and malfunctions will occur.

It is the object of the present invention to avoid these disadvantages and to enable a secure retrieval or delivery of different kinds of storage goods from/to a substantially planar rack shelf.

This is achieved in accordance with the invention in such a way that, as it receives articles, preferably during displacement in a direction transverse to the rack aisle, the loading platform is lowered on the side facing the set-down location.

This ensures simple threading of the loading platform between the articles and the set-down location. The lowering movement ensures that different articles are removed reliably from a flat rack shelf or are placed on the same, even when the articles are not rounded off at their edges or are rounded off only to a very limited extent. In addition, a possible height tolerance between the loading platform and the rack shelf is compensated by the lowering movement.

The loading platform is not moved in a linear manner transversally to the rack aisle, but lowered at first to the level of the rack shelf of the set-down location, and is only pushed beneath the article when it touches the rack shelf with a sharp edge on the side of the rack shelf. During this movement, differences in height between the load-bearing means and the rack shelf are compensated which are obtained inevitably due to production tolerances of the load-bearing means and the rack. The lowering movement on the side of the rack shelf ensures that the sharp edge of the loading platform will also sit close to the level of the rack shelf, so that no difference in height can be formed between the edge of the loading platform and the rack shelf, which would otherwise lead to damage to the article. The loading platform can thus be pushed beneath the article in an unhindered manner and without damaging the same. This combined motion, lowering and pushing motion of the loading platform beneath the article, is the precondition for error-free and product-protecting storage and retrieval of the article.

In an embodiment with at least one pivoting holding means which can be pivoted about a rotational axis between a holding position and a release position, it can be provided that the holding means is formed by at least one folding arm and that the rotational axis of the holding means is arranged in a transverse direction relative to the rack aisle, with a folding arm preferably being arranged at each corner of the load-bearing means which is substantially rectangular in its layout.

The folding arms are exposed at their ends, as a result of which the maximum height of the containers to be transported is not limited by the holding means.

It is especially advantageous when two folding arms each which are spaced from each other in the direction of the rotational axis are arranged on a common shaft.

An especially simple construction and actuation is obtained when two folding arms each which are spaced from each other in the direction of the rotational axis are arranged on a common shaft section and form a holding unit, with preferably at least one holding means being displaceable in the longitudinal direction of the rotational axis.

In a further embodiment with at least one holding means which can be moved between a holding position and a release position, the holding means can be formed by a holding frame which is arranged to be swivelable about at least one rotational axis preferably aligned in the direction towards the rack aisle or is arranged to be displaceable transversally to the rack aisle. In order to ensure an unhindered displacement of the loading platform, it is advantageous when the holding frame can be lowered at least on the side of the set-down location beneath the level of the loading platform.

For pivoting and/or displacing the holding means, at feast one electric, pneumatic or hydraulic actuating device can be provided.

The holding means is used as a holding, fixing and centering device for the article. It is especially advantageous in this respect when at least one holding means is displaceable in the longitudinal direction of the rotational axis. This allows for precise positioning of the article on the set-down locations and ensures a sufficient safety distance between the load-bearing means and the rack during the displacement through the rack aisle.

The loading platform is provided with a sharp edge on its sides facing the set-down locations and is thus capable of penetrating between article and set-down location with minimal friction. In order to further facilitate such penetration, it is advantageous when the set-down location is provided at its front side with an oblique insertion portion, thus virtually producing a funnel for inserting the loading platform.

For receiving and delivering light articles, the loading platform can be arranged as a simple metal plate with oblique edges. For lateral guidance and stabilization of the loading platform and the articles it is advantageous when the sides of the loading platform are slightly bent in relationship to the set-down location.

In order to enable a further extension of the loading platform in both directions, it is provided that the loading platform is displaceable by a traction means, preferably a cable, a toothed belt or a chain.

In a simple embodiment of the invention it is provided that the traction means is provided with an ending configuration and the ends of the traction means are connected with opposing edges of the loading platform which are arranged in the longitudinal direction to the rack aisle, with the traction means being deflected at least twice and the areas of the traction means between the deflections and the ends being guided to cross each other, when seen in a view in the longitudinal direction of the rack aisle.

In order to enable automatic removal and delivery of different articles from/to the rack shelf, it can be provided that the loading platform comprises at least one ramp with a defined height on its bottom side, preferably in the region of at least one edge facing the place on the shelf, which ramp is arranged in such a way that it is lowered by cooperation with a guide means during a displacement movement of the loading platform.

As an alternative, the traction means can be provided with an endless revolving configuration, with preferably the traction means comprising at least a first driver which is preferably connected in an interlocking manner with the loading platform. A displacement of the loading platform in both directions is possible when the traction means comprises at least a second driver which can be connected in an interlocking manner with the loading platform, with the second driver acting upon the loading platform preferably in the region of the side edges facing the set-down locations.

Preferably, a bearing block with a defined height for receiving the loading platform is provided in the region of each driver. When separating at least one driver from the loading platform, it is lowered by a predefined amount, with the loading platform being linked to a stop and/or the rack shelf.

The traction means for driving the loading platform is arranged beneath the loading platform in a simple embodiment. As an alternative to this it is also possible to arrange the traction means with the drivers laterally to the loading platform in the plane of the same or at least partly above the loading platform.

For heavier articles, the loading platform can be provided with a sliding lining, e.g. coated with Teflon or provided with sliding plastic strips. Furthermore, small sliding bearings or bearing pins can be provided to reduce friction between the loading platform and the articles or the shelf. Surfaces subject to shearing stresses are preferably made of special steel.

In a further embodiment of the invention it can be provided that the loading platform consists of at least two partial platforms which are displaceable next to one another in a transverse direction relative to the rack aisle and which are divided at a ratio of 1:2 for example. This enables removing and delivering articles of different width from and to set-down locations of different widths. Preferably, each of the two partial platforms is displaceable in a transverse direction independent of one another.

The invention will be explained below in greater detail by reference to the drawings, wherein:

FIG. 1 shows a load-bearing means in accordance with the invention in a first embodiment in a side view when receiving a load in a first position;

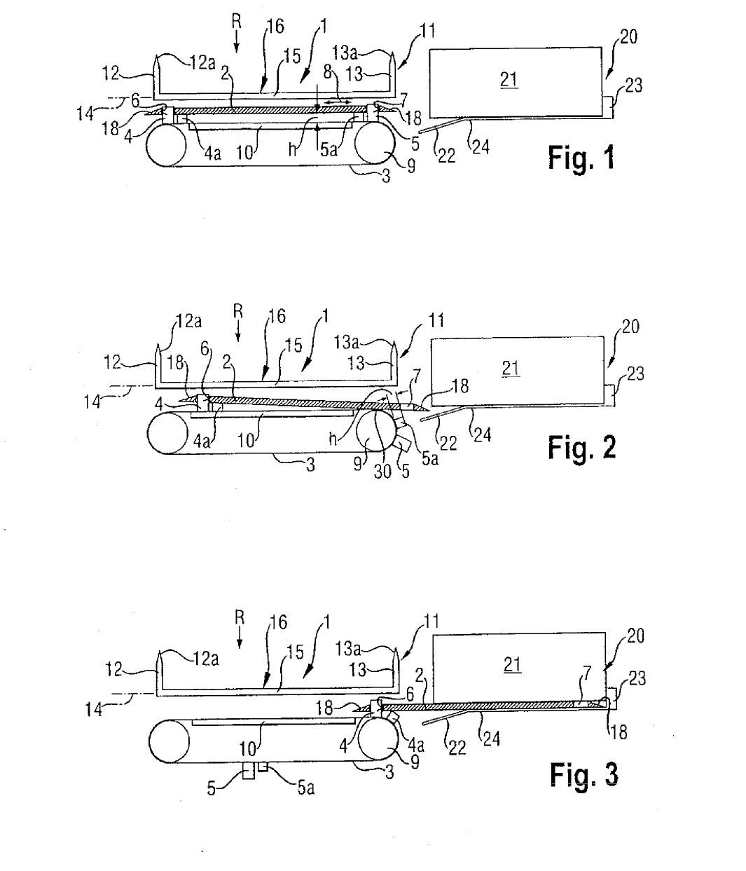

FIG. 2 shows this load-bearing means when receiving a load in a second position;

FIG. 3 shows this load-bearing means when receiving a load in a third position;

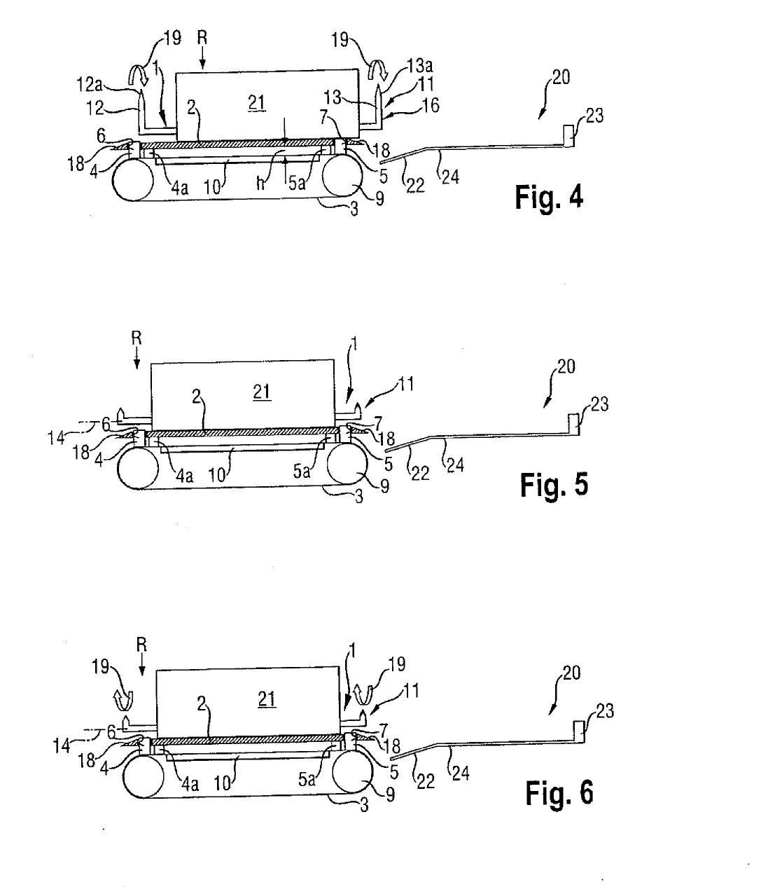

FIG. 4 shows this load-bearing means when receiving a load in a third position;

FIG. 5 shows this load-bearing means when receiving a load in a third position;

FIG. 6 shows this load-bearing means when delivering a load in a first position;

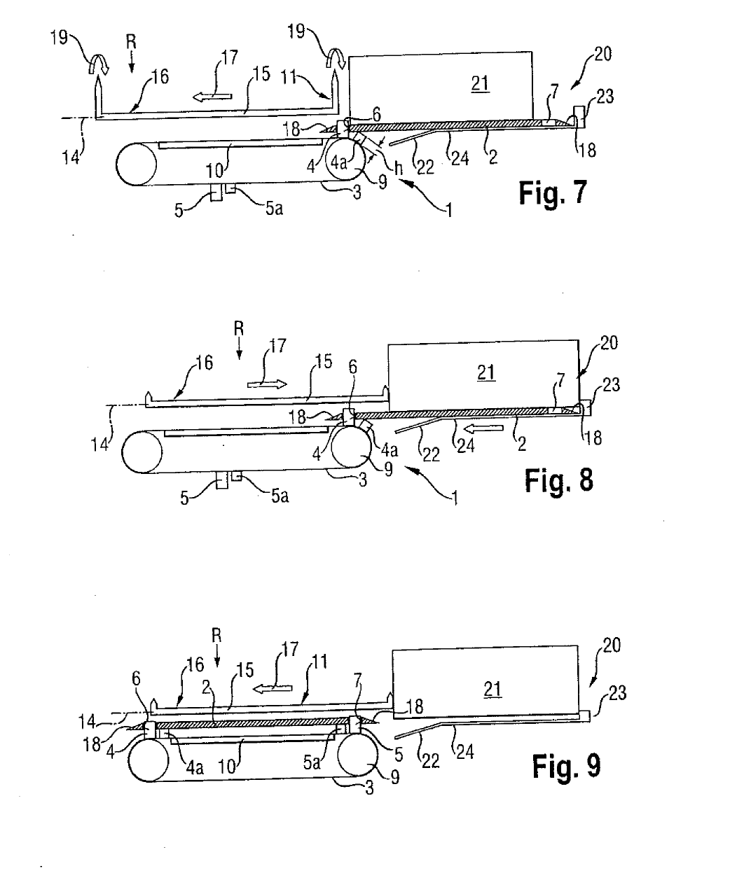

FIG. 7 shows this load-bearing means when delivering a load in a second position;

FIG. 8 shows this load-bearing means when delivering a load in a third position;

FIG. 9 shows this load-bearing means when delivering a load in a fourth position;

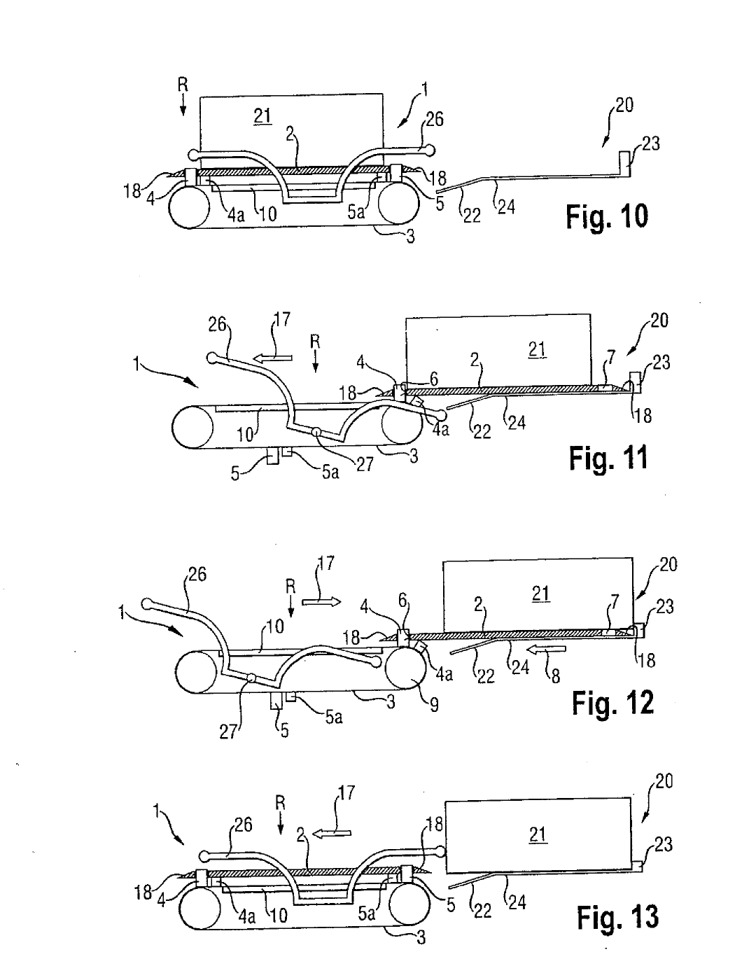

FIG. 10 shows a load-bearing means in a second embodiment in a side view when delivering a load in a first position;

FIG. 11 shows this load-bearing means when delivering a load in a second position;

FIG. 12 shows this load-bearing means when delivering a load in a third position;

FIG. 13 shows this load-bearing means when delivering a load in a fourth position;

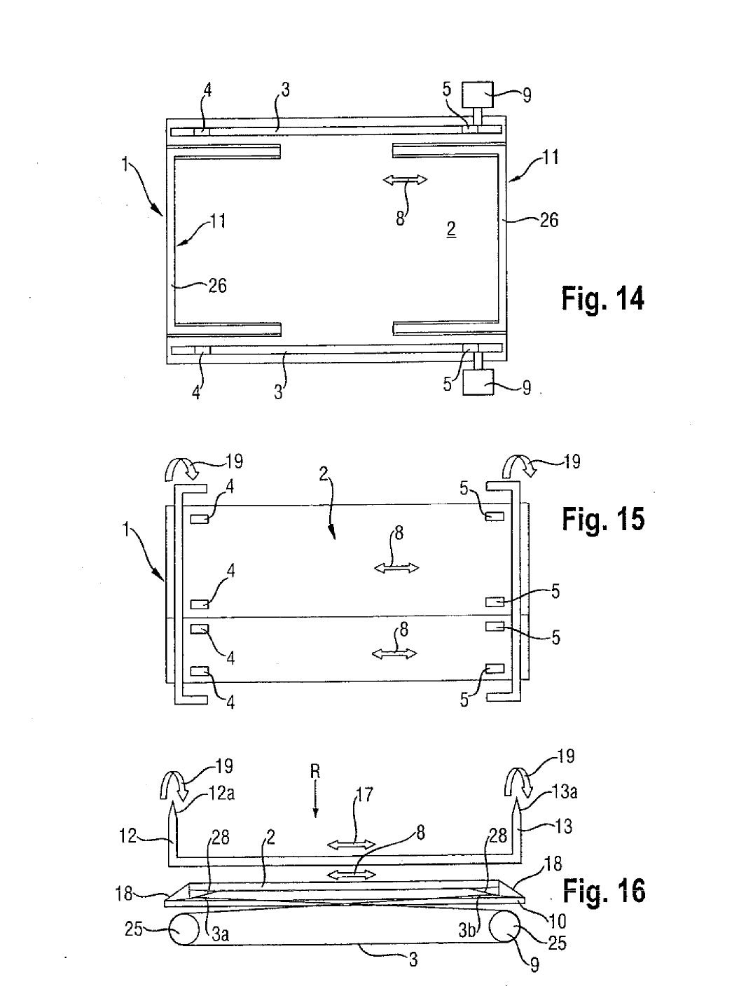

FIG. 14 shows this load-bearing means in a top view;

FIG. 15 shows a load-bearing means in a third embodiment in a top view;

FIG. 16 shows this load-bearing means in a side view;

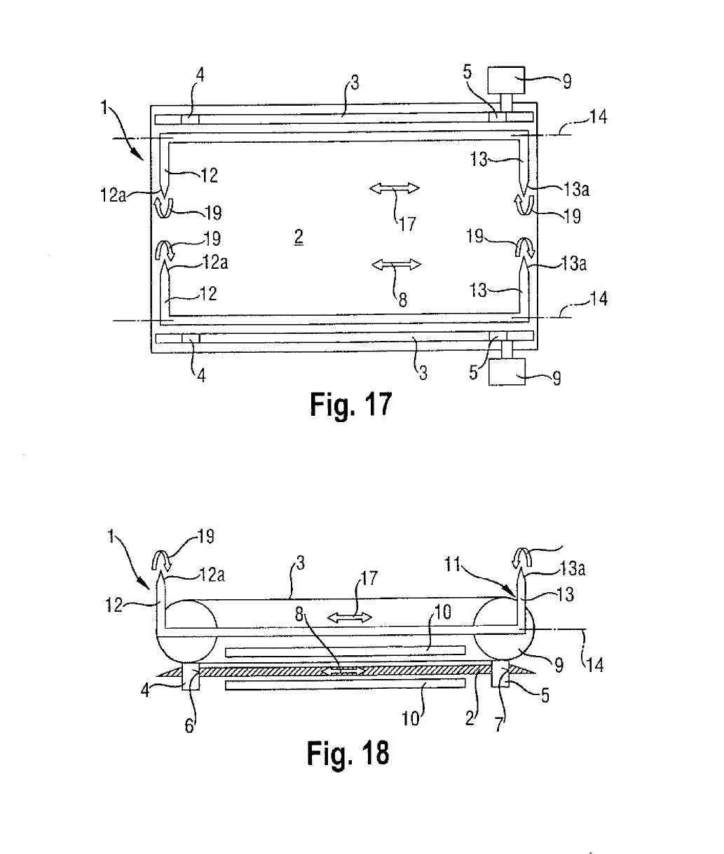

FIG. 17 shows a load-bearing means in accordance with the invention in a fourth embodiment in a top view, and

FIG. 18 this load-bearing means in a side view.

Parts with the same function are provided in the embodiments with the same reference numerals.

The load-bearing means 1 comprises a loading platform 2 which can be displaced by a traction means 3 transversally to the rack aisle R. The traction means 3, which is a chain, a belt or the like for example, comprises drivers 4, 5 which engage in an interlocking manner in respective receiving openings 6, 7 of the loading platform 2 and thus ensure a displacing movement of the loading platform 2 according the direction of arrow 8. The traction means 3 is driven by a motor 9. Reference numeral 10 designates a guide means for the loading platform 2.

The load-bearing means 1 further comprises a holding means 11 which is formed by folding arms 12, 13 which can be pivoted about a rotational axis 14 between a holding position and an idle position. One folding arm 12, 13 is arranged approximately in the region of each corner of the substantially rectangular loading platform 2. The ends 12a, 13a of each folding arm 12, 13 which are averted from the rotational axis 14 are exposed with respect to each other, which therefore means they are not connected with each other. Two folding arms 12, 13 which are each swivelable about the same rotational axis 14 are connected with each other by means of a shaft portion 15 and form a holding unit 16. The holding unit 16 is displaceable in a transverse direction relative to the rack aisle R in the direction of the rotational axis 14, so that the loading and unloading processes of the articles 21 can be supported.

The load-bearing means 1 is located in front of a set-down location 20, on the rack shelf 24 of which an article 21 is located. For receiving the article 21, the loading platform 2 is displaced in the direction towards the set-down location 20 by the traction means 3, so that the loading platform 2 comes to lie between the set-down location 20 and the article 21. In order to facilitate threading, the edge 18 of loading platform 2 is beveled and provided with a sharp edge on each side facing the set-down location 20. The set-down location 20 further comprises an oblique insertion portion 22 which facilitates the threading of the loading platform 2. Reference numeral 23 relates to a stop for the article 21 in the rack.

The loading platform 2 performs a tilting movement during the displacing movement in a transverse direction relative to the rack aisle R, as shown in FIG. 2. This ensures a virtual “shoveling” of the article 21 onto the loading platform 2.

This function can be realized in that bearing blocks 4a, 5a are provided for the loading platform 2 of defined height h in the region of the drivers 4, 5, which bearing blocks are also moved by the traction means 3 like the drivers 4, 5. Once a driver 5 unlatches during the transverse movement of the loading platform 2, loading platform 2 tilts onto a stop 30 or the rack shelf 24 of the set-down location 20, thus leading to a certain inclination of the loading platform 2. Loading platform 2 is thus lowered by the predetermined height h to the floor of the rack shelf prior to the actual advancement of the rack. This enables the loading platform to slide beneath the article 21 without damaging any of the article, so that in many cases it is possible to omit sharp edges 18 and/or oblique insertion portions 22.

FIG. 3 shows the load-bearing means 2 with extended loading platform 2. The loading platform 2 is disposed between the set-down location 20 and the article 21. It can clearly be seen that a second driver 5 or a group of second drivers 5 is unlatched and the loading platform 2 is connected with the traction means 3 only with a first driver 4 or a group of first drivers 4. This ensures a very long extension of the loading platform 2 into the depth of the rack.

Once the article 21 has been received by the loading platform 2, it is retracted again by the traction means 2 and the drivers 4. During this process, the folding arms are folded upwardly and are situated in their idle. position. In the case of retracted loading platform 2, the folding arms 12, 13 are thereafter folded downwardly to their holding, fixing and centering position, as indicated in FIG. 4 by the arrows 19. By displacing the holding unit 16 in the direction towards the rotational axis 14, the article 21 can be positioned in a precise manner on the loading platform 2.

FIG. 5 shows the load-bearing means 1 with a fixed and arrested article 21, with the folding arms 12, 13 being situated in their holding position. The load-bearing means 1 is now able to cover any desired routes with the article 21 in the rack aisles R. The article 21 is held securely even in the case of transverse movements and around curves.

FIGS. 6 to 9 show the load-bearing means 1 while delivering a load.

In a first step shown in FIG. 6, the folding arms 12, 13 are swiveled upwardly in their idle position. Then the loading platform 2 is displaced transversally in the direction of its set-down location 20 by the traction means 3 until the stop 23, with a second driver 5 being unlatched from the loading platform 2. By displacing and swiveling the folding arms 12, 13 according to the arrows 17, 19, the article 21 is displaced up to stop 23 on the loading platform 2 to the correct position of the set-down location 20, as shown in FIG. 8. When the article 21 is brought to its correct final position, the loading platform 2 is retracted, with the holding unit 16 holding the article 21 at its position. Holding unit 16 is retracted only then, as shown in FIG. 9.

FIGS. 10 to 13 show an embodiment in which the holding means 11 is formed by a holding frame 26 which is arranged to be swivelable about at least one rotational axis 27 which is preferably aligned in the direction of the rack aisle R and/or to be displaceable in a transverse direction to the rack aisle R (arrow 17). The holding frame 26 can be lowered beneath the level of the loading platform 2 at least at the side of the set-down location 20. This ensures that the loading platform can be moved beyond the holding frame 26 in an unobstructed manner in a transverse direction relative to the rack aisle R.

FIG. 15 shows an embodiment in which the loading platform 2 is divided into two partial platforms 2a, 2b at a ratio of 1:2. The partial platforms 2a, 2b can be extended independent from each other. This allows receiving articles 2 of different size. In order to enable this, separate drive means are necessary for each partial platform 2a, 2b.

As an alternative to an endlessly revolving traction means 3, it is also possible to provide a traction means 3 with two ends 3a, 3b which act upon edges 18 of the loading platform 2 (FIG. 16), which edges are arranged in the longitudinal direction to the rack aisle R. The traction means 3 is guided about two deflecting means formed by deflection rollers. The areas of the traction means 3 between the deflection means 25 and the ends 3a, 3b are guided to cross each other, as seen in a view in the longitudinal direction of the rack aisle R. The loading platform 2 can thus be displaced without the use of separate drivers directly by means of the traction means 3 in a direction transversally to the rack aisle R. The loading platform 2 comprises ramps 28 in the area of the edges 18, through which the loading platform slides along the edge of the guide means 10 and is lowered according to the ramp height h. The points of attack of the ends 3a, 3b of the traction means 3 can be arranged adjacent to or between the ramps 28.

FIGS. 17 and 18 show a load-bearing means 1, in which the loading platform 2 is not arranged above the traction means 3, but beneath and/or to the side of the traction means 3. Guide means 10 are provided both above and below the loading platform. The loading and unloading process occurs in analogy to FIGS. 1 to 9.

The load-bearing means 1 is very sturdy and is provided with a simple configuration in respect of its construction and is especially also suitable for simple and small rack vehicles and rack operating devices. Retrieving and delivering loads can occur in a manner substantially independent of the geometry of the article. Different boxes can thus be handled for example.

1-25. (canceled)

26. A load-bearing means for storing articles in a set-down location, and retrieving said articles therefrom, with a loading platform which can be displaced transversely to a rack aisle and, for receiving articles, is pushed between a rack shelf and the articles, wherein the loading platform is lowered on the side facing the set-down location during displacement in a direction transverse to the rack aisle, wherein the loading platform is displaceable by a traction means and wherein the traction means is provided with an ending configuration and the ends of the traction means are connected with opposing edges of the loading platform which are arranged in the longitudinal direction to the rack aisle, with the traction means being deflected at least twice and the areas of the traction means between the deflections and the ends being guided to cross each other when seen in a view in the longitudinal direction of the rack aisle.

27. The load-bearing means according to claim 26, comprising at least one pivoting holding means which can be pivoted about a rotational axis between a holding position and a release position, wherein the holding means is formed by at least one folding arm and the rotational axis of the holding means is arranged in a transverse direction relative to the rack aisle.

28. The load-bearing means according to claim 27, wherein the folding arm is exposed at its end averted from the rotational axis.

29. The load-bearing means according to claim 27, wherein a folding arm is arranged at each corner of the load-bearing means, which is substantially rectangular.

30. The load-bearing means according to claim 27, wherein two folding arms which are spaced from one another in the direction of the rotational axis are arranged on a common shaft portion and form a holding unit.

31. The load-bearing means according to claim 27, wherein at least one holding means is displaceable in the longitudinal direction of the rotational axis.

32. The load-bearing means according to claim 31, wherein at least two holding units which are arranged on opposite sides of the loading platform can be displaced at the same time by an actuating device and/or can be pivoted in a diametrically opposed manner.

33. The load-bearing means according to claim 27, including at least one electric, pneumatic or hydraulic actuating device for pivoting and/or displacing the holding means.

34. The load-bearing means according to claim 27, wherein the holding means forms a holding, fixing and centering device for the article.

35. The load-bearing means according to claim 27, wherein the loading platform is provided with a sharp edge at least on one side facing a rack.

36. The load-bearing means according to claim 26, comprising at least one holding means which can be moved between a holding position and a release position, wherein the holding means is formed by a holding frame which is arranged to be swivelable about a rotational axis which is aligned in the direction of the rack aisle and/or to be displaceable in a transverse direction relative to the rack aisle.

37. The load-bearing means according to claim 36, wherein the holding frame can be lowered beneath the level of the loading platform at least on the side of the set-down location.

38. The load-bearing means according to claim 26, wherein the loading platform is displaceable by a traction means a cable, a toothed belt or a chain.

39. The load-bearing means according to claim 38, wherein the traction means is arranged at least partly above or to a side of the loading platform.

40. The load-bearing means according to claim 26, wherein the loading platform comprises at least one ramp with a defined height on its bottom side in a region of at least one edge facing the set-down location, which ramp is arranged in such a way that it is lowered by cooperation with a guide means during a displacement movement of the loading platform.

41. The load-bearing means according to claim 26, wherein the loading platform includes a sliding lining or sliding strips made of plastic.

42. The load-bearing means according to claim 26, wherein the loading platform is divided into at least two partial platforms at a ratio of 1:2.
